(19) United States
(12) Patent Application Publication
(10) Pub. No.: US 2009/0058732 A1
(43) Pub. Date: Mar. 5, 2009

(54) Wideband antenna unit

(76) Inventors: Hisamatsu Nakano, Tokyo (JP); Akira Miyoshi, Tokyo (JP); Takaaki Kondo, Tokyo (JP); Satoshi Hattori, Tokyo (JP); Takaaki Kondo, Tokyo (JP); Junji Yamauchi, Tokyo (JP)

Correspondence Address: FRISHAUF, HOLTZ, GOODMAN & CHICK, PC, 220 Fifth Avenue, 16TH Floor, NEW YORK, NY, 10001-7708, US

(21) Appl. No.: 11/988,581

(22) PCT Filed: Mar. 2, 2006
(86) PCT No.: PCT/JP2006/303987

§ 371 Date: Aug. 7, 2008

(30) Foreign Application Priority Data
Jul. 12, 2005 (JP) 2005-202444

(51) Int. Cl. H01Q 9/04

(52) U.S. Cl. 343/700 MS

(57) ABSTRACT

To provide a thin wideband antenna unit capable of shrinking the size of a radiation element in a case where a dielectric is not used.

In a wideband antenna unit 10 having a ground plate 12 and a flat shaped radiation element 14 disposed on a plane (x, y) flush with a plane where the ground plate extends, the radiation element 14 has an elliptically shape. The radiation element 14 and the ground plate 12 are apart from each other by a predetermined feeding distance Δ_{FD}. A ratio between an outside diameter 2aₒᵤₜ in an ellipse's x-direction and an outside diameter 2bₒᵤₜ in an ellipse's y-direction is 8:5. The elliptically shaped radiation element 14 has an elliptically shaped opening 14a which is concentric O with the elliptically shape. An inside diameter 2bᵢₙ in the ellipse's y-direction is half of an outside diameter 2bₒᵤₜ in the ellipse's y-direction. It is desirable that an inside diameter 2aᵢₙ of the elliptically shaped opening 14a in the ellipse's x-direction is not more than half of the outside diameter 2aₒᵤₜ in the ellipse's x-direction.

### TECHNICAL FIELD

This invention relates to a wideband antenna unit and, more particular, to an antenna for a UWB (Ultra Wide band).

### BACKGROUND ART

The UWB means an ultra wideband radio like its name and is a broad sense term referring to any radio transmission system that occupies a bandwidth greater than 25 percent of the center frequency, or a bandwidth equal to or more 1.5 GHz. In a word, it is technology for communicating using short pulses (normally of 1 ns or less) of ultra wideband so as to start a revolution in radio.

A crucial difference between a conventional radio and the UWB is the presence or absence of a carrier wave. The conventional radio modulates a sinusoidal wave having a frequency called the carrier wave using various methods to transmit and receive data. On the other hand, the UWB does not the carrier wave. In the manner which is written in definition of the UWB, it uses the short pulses of the ultra wideband.

Like its name, the UWB has a frequency band of the ultra wideband. On the other hand, the conventional radio has only a narrow frequency band. This is because it is possible for the narrow frequency band to put electric waves to practical use. The electric waves are finite resources. The reason whey the UWB is widely noticed in spite of the ultra wideband is output energy of each frequency. The UWB has a very small output each frequency in place of a wide frequency band. Inasmuch as it has magnitude so as to be covered with noises, it reduces interface with other wireless spectra. The reason whey the FCC (Federal Communications Commission gives permission on contingent gives consideration so that interference between other radio communications presents no problem.

Inasmuch as the UWB has the ultra wideband, its band is covered with an already-existing radio communication service. Therefore, at the present time, it is put into a situation that the band of the UWB is restricted in range from 3.1 GHz to 10.6 GHz.

In addition, antennas basically use a resonance phenomenon. The antenna has a resonance frequency which is determined by its length, it is difficult for the UWB including a lot of frequency components to make the antenna resonate. Accordingly, the wider the frequency band of the electric wave to be transmitted is, the more difficult it makes a plan for the antenna.

Taiyo Yuden Co. Ltd. has successfully developed a very miniaturized ceramic chip antenna having a shape of 10×8 mm and a thickness of 1 mm for applications of UWB which presently becomes a focus of attention in a field of radio communication of close range as next-generation technology which is capable of simultaneously realizing large-capacity data transmission and low power consumption. By developing the antenna, it has become the responsibility of the wireless industry to help UWB make the transition from military applications to widespread commercial use for connecting at a very high speed data between digital devices such as PDP (plasma display panel) television, a digital camera, or the like and it is possible to downsize equipment which come into sight for mobile use.

In addition, such a UWB antenna can be used for various purposes such as Bluetooth (registered trademark), wireless LAN (Local Area Network), or the like.

Bluetooth is a cutting-edge open specification that enables short-range wireless communications of speech and data between desktop and notebook computers, PDAs (personal digital assistants), cellular phones, printers, scanners, digital cameras, and even household electrical appliances. Bluetooth can be used in the world because it operates using a globally available frequency band (2.4 GHz) for worldwide compatibility. In a nutshell, Bluetooth unplugs your digital peripherals and makes cable clutter a thing of the past.

The wireless LAN is a LAN using a transmission path except for a wire cable, such as electric waves, infrared rays, or the like.

Various wideband antenna devices are already known in the art. By way of example, a wideband antenna device with which interference to be exerted by an unwanted frequency band or a frequency band out of a target is reduced by forming the wideband antenna device matched with target frequency characteristics is known (see, for example, Patent Document 1). The wideband antenna device disclosed in the Patent Document 1 comprises a flat conductive ground plate and a flat radiation conductor standing up above a plane of the flat conductive ground plate in a direction to intersect the flat conductive ground plate. A feeding point is provided on or near an outer peripheral portion of the flat radiation conductor. The flat radiation conductor has one or more notches formed by cutting a part of the flat radiation conductor.

In addition, a wideband antenna device with a wide band and a small size that counters the problems such that costs, usage purposes or mounting on equipment and that cuts manufacturing costs is known (see, for example, Patent Document 2). The wideband antenna device disclosed in the Patent Document 2 comprises a flat conductive ground plate and a polygonal flat radiation conductor standing up above a plane of the flat conductive ground plate in a direction to intersect the flat conductive ground plate. The polygonal flat radiation conductor has a top which is used as a signal feeding point.

Furthermore, a wideband antenna device which uses a plate-shaped radiation conductor as a radiation conductor and which can be made more compact is known (see, for example, Patent Document 3). The wideband antenna device disclosed in the Patent Document 3 comprises a flat conductive ground plate and a flat radiation conductor standing up above a plane of the flat radiation ground plate in a direction to intersect the flat conductive ground plate. In a state where the flat radiation conductor stands up above the plane of the flat conductive ground plate, the flat radiation conductor comprises a plurality of conductive portions so as to arrange in the direction to intersect the flat conductive ground plate. Through a low conductivity member having conductivity of almost 0.1 or more and 10.0 or less, the plurality of conductive portions are connected.

In addition, a thin-type wideband antenna device is known (see, for example, Patent Document 4). The wideband antenna device disclosed in the Patent Document 4 includes a conductive ground plate and a radiation conductor that are connected with a feeder line for transmitting power, at least parts of which are disposed so as to face each other. Interposed between the parts that the reference conductor and the radiation conductor face each other, a substance has conductivity which is about 0.1 [/Ωm] through 10 [/Ωm] in the operational radio frequency.

On the other hand, some of the present co-inventors have already proposed a UWB antenna which is capable of widening the band and which is capable of improving a frequency characteristic (see, for example, Patent Document 5). The UWB antenna disclosed in the Patent Document 5 comprises an upper dielectric, a lower dielectric, and a conductive pattern sandwiched therebetween. The conductive pattern has a feeding point at a substantially center portion of a front surface. The conductive pattern comprises a reversed triangular portion having a right-hand taper part and a left-hand taper part which widen from the feeding point at a predetermined angle toward a right-hand side surface and a left-hand side surface, respectively, and a rectangular portion having a base side being in contact with an upper side of the reversed triangular portion. In addition, the feeding point of the conductive pattern is electrically connected to a ground plate which extends in a plane flush with that of the conductive pattern (a radiation element).

Patent Document 1: JP 2003-273638 A

Patent Document 2: JP 2003-283233 A

Patent Document 3: JP 2003-304114 A

Patent Document 4: JP 2003-304115 A

Patent Document 5: JP 2005-94437 A

### DISCLOSURE OF INVENTION

### Problem to be Solved by the Invention

In the wideband antenna devices disclosed in the above-mentioned Patent Documents 1 to 3, the flat radiation conductor stands up above the plane of the flat conductive ground plate in the direction to intersect the flat conductive ground plate. Therefore, the wideband antenna devices are high in stature.

On the other hand, inasmuch as the thin-type wideband antenna device disclosed in Patent Document 4 includes the conductive ground plate and the radiation conductor which face each other, it is difficult to make thin because the wideband antenna device has thickness a certain extent.

In addition, inasmuch as the UWB antenna unit disclosed in Patent Document 5 has structure of the radiation element where the conductive pattern is sandwiched between the upper dielectric and the lower dielectric, it is unsuitable to make thin because the UWB antenna unit has thickness a certain extent in the manner similar in a case of the above-mentioned Patent Document 4.

Therefore, the present co-inventors had been prototyped thin UWB antennas without using any dielectric. However, in this event, a radiation element of the UWB antenna has a size of 40×8 mm and it was understood that it is impossible to become smaller in size.

It is therefore an object of the present invention to provide a thin wideband antenna unit which is capable of shrinking the size of a radiation element in a case where a dielectric is not used.

### Means for Solving Problem

According to this invention, it is provided with a wideband antenna unit comprising a ground plate and a flat shaped radiation element disposed on a plane flush with a plane in which the ground plate extends, characterized in that the radiation element has an elliptic shape.

In the wideband antenna unit of the above-mentioned this invention, the radiation element and the ground plate may be apart from each other by a predetermined feeding distance. In addition, a ratio between an outside diameter in a major axis direction of the elliptic shape and an outside diameter in a minor axis direction of the elliptic shape may be, for example, 8:5. The elliptically shaped radiation element preferably may have an elliptically shaped opening which is concentric with the elliptic shape. An inside diameter of the elliptically shaped opening in the minor axis direction of the elliptic shape may be, for example, half of an outside diameter in the minor axis direction of the elliptic shape. In addition, an inside diameter of the elliptically shaped opening in the major axis direction of the elliptic shape preferably may be not more than half of the outside diameter in the major axis direction of the elliptic shape.

### EFFECT OF THE INVENTION

Inasmuch as this invention is provided with a flat shaped radiation element on a plane flush with a plane in which a ground plate extends and the radiation element has an elliptic shape, this invention has the effect of shrinking the size of the radiation element in a case where a dielectric is not used.

### BRIEF DESCRIPTION OF THE DRAWINGS

FIG. 1 is a plan view showing a wideband antenna unit according to an embodiment of the present invention conventional.

FIG. 2 is an enlarged plan view showing a radiation element for use in the wideband antenna unit illustrated in FIG. 1.

FIG. 3 is a view showing a characteristic of VSWR in the wideband antenna unit illustrated in FIG. 1 when an inside radius in an x direction is changed.

### EXPLANATIONS OF REFERENCE NUMERALS

10 wideband antenna unit

12 ground plate

14 elliptically shaped radiation element

14a elliptically shaped opening

### BEST MODE FOR CARRYING OUT THE INVENTION

New, the description will be made as regards an embodiment of this invention in detail with reference to drawings.

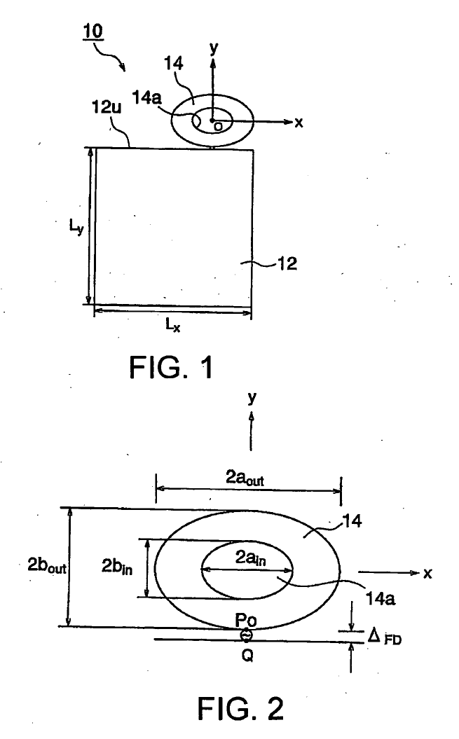

Referring to FIGS. 1 and 2, a wideband antenna unit 10 according to an embodiment of the present invention will be described. FIG. 1 is a plan view of the wideband antenna unit 10 while FIG. 2 is an enlarged plan view showing a radiation element 14 for use in the wideband antenna unit 10 illustrated in FIG. 1. The wideband antenna unit 10 comprises a ground plate 12 and a radiation element 14. Herein, as shown in FIG. 1, the origin point 0 is a center of radiation element 14, an x-axis extends sidewise (in a width direction; a horizontal direction) and a y-axis extends lengthwise (in a longitudinal direction; up and down).

The ground plate 12 has a rectangular shape which has a width (x-axis) of Lx and a length (y-axis) of Ly. In the example being illustrated, the width (x-axis) Lx is equal to 45 mm and the length (y-axis) Ly is equal to 45 mm. That is, the ground plate 12 has a square shape.

In the vicinity of an upper edge (an upper side) 12u of the ground plate 12, the radiation element 14 is disposed to the right of a center thereof. The radiation element 14 has a flat shape disposed in a plane (x, y) flush with a plane in which the ground plate 12 extends. The radiation element 14 is made of a conductive plate. Accordingly, the radiation element 14 does not use dielectrics such as a radiation element for the UWB antenna unit disclosed in the above-mentioned Patent Document 5.

Referring now to FIG. 2, structure of the radiation element 14 will be described in detail. The radiation element 14 has an elliptic shape. That is, It will be assumed that the radiation element 14 has an outside diameter 2aₒᵤₜ in an ellipse's x-direction (a major axis direction) and an outside diameter 2bₒᵤₜ in an ellipse's y-direction (a minor axis direction). In this event, the outside shape of the radiation element 14 is the elliptic shape on the plane (x, y) that is represented by x²/aₒᵤₜ²+y²/bₒᵤₜ²=1 (aₒᵤₜ>bₒᵤₜ>0). In the example being illustrated, the outside diameter 2aₒᵤₜ in the major axis direction (the x-direction) is equal to 24 mm while the outside diameter 2bₒᵤₜ in the minor axis direction (the y-direction) is equal to 15 mm. That is, a ratio between the outside diameter 2aₒᵤₜ in the ellipse's major axis direction and the outside diameter 2bₒᵤₜ in the ellipse's minor axis direction is 8:5.

As shown in FIG. 2, the radiation element 14 and the ground plate 12 are apart from each other by a predetermined feeding distance Δ_{FD}. Through the feeding distance Δ_{FD}, the ground plate 12 is provided with a ground feeding point Q and the radiation element 14 is provided with a signal feeding point Po. In the example being illustrated, the feeding distance Δ_{FD} is equal to 0.375 mm.

In the example being illustrated, the elliptically shaped radiation element 14 has an elliptically shaped opening 14a which is concentric O with the elliptic shape. However, in the manner which will later be described, the elliptically shaped opening 14a may be absent. Herein, it will be assumed that an inside diameter (i.e. an inside diameter in the x-direction) of the elliptically shaped opening 14a in the ellipse's x-direction (the major axis direction) is represented by 2aᵢₙ while an inside diameter (i.e. an inside diameter in the y-direction) of elliptically shaped opening 14a in the ellipse's y-direction (the minor axis direction) is represented by 2bᵢₙ.

In the example being illustrated, an inside radius bin in the y-direction is set so that bᵢₙ=3.75 mm. Accordingly, the inside diameter 2bᵢₙ in the y-direction is equal to 7.5 mm. In other words, the inside diameter (the inside diameter in the y-direction) 2bᵢₙ of the elliptically shaped opening 14a in the ellipse's y-direction (the minor axis direction) is half of the outside diameter 2bₒᵤₜ in the ellipse's y-direction (the minor axis direction). In addition, in the example being illustrated, an inside radius aᵢₙ in the x-direction is set so that aᵢₙ=6 mm. Accordingly, the inside diameter 2aᵢₙ in the x-direction is equal to 12 mm. In other words, the inside diameter (the inside diameter in the x-direction) 2aᵢₙ of the elliptically shaped opening 14a in the ellipse's x-direction (the major axis direction) is half of the outside diameter 2aₒᵤₜ in the ellipse's x-direction (the major axis direction). That is, a ratio between an outside diameter and an inside diameter of the elliptically shaped radiation element 14 becomes 2:1.

In the manner which is well known in the art, it is generally preferable for an antenna characteristic required to an antenna unit that a voltage standing wave ratio (VSWR) is close one as much as possible. Desirably, the VSWR may be not more than two.

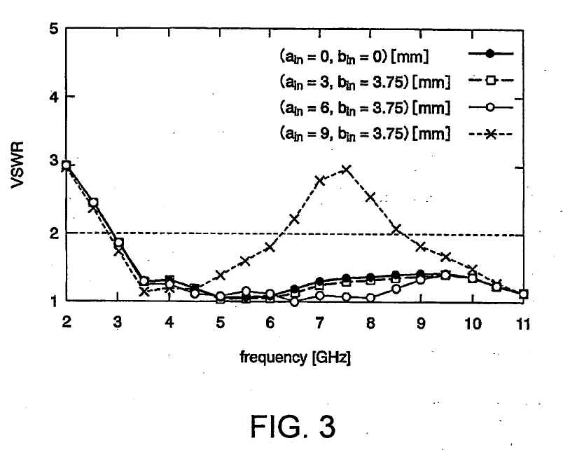

FIG. 3 shows a frequency characteristic of a VSWR when the inside radius aᵢₙ in the x-direction is changed. The illustrated frequency characteristic of the VSWR is analyzed by using the FDTD method (the finite-difference time-domain method). In addition, as mentioned before, the inside radius bin in the y-direction is fixed to 3.75 mm. In FIG. 3, the abscissa represents a frequency [GHz] and the ordinate represents the VSWR.

As seen in FIG. 3, it is understood that the VSWR is 2 or less in a wide frequency range which is over from 3 GHz to 11 GHz although the elliptically shaped opening 14a is absent (aᵢₙ=0 mm, bᵢₙ=0 mm). In addition, it is understood that a case where the inside radius aᵢₙ in the x-direction is 3 mm has the frequency characteristic of the VSWR which is substantially equal to that in the case where the elliptically shaped opening 14a is absent. Furthermore, it is understood that a case where the inside radius aᵢₙ in the x-direction is 6 mm has the frequency characteristic of the VSWR which is improved in comparison with the case where the elliptically shaped opening 14a is absent. However, it is understood that a case where the inside radius aᵢₙ in the x-direction is 9 mm has the frequency characteristic of the VSWR which become deteriorated in comparison with the case where the elliptically shaped opening 14a is absent.

In the manner which is described above, it is understood that the characteristic of the VSWR is equivalent to or improved in comparison with the case where the elliptically shaped opening 14a is absent if the inside diameter 2aᵢₙ of the elliptically shaped opening 14a in the ellipse's x-direction (the major axis direction) is the half or less of the outside diameter 2aₒᵤₜ in the ellipse's x-direction (the major axis direction).

In the manner which is obvious described above, it is possible to realize a broadband characteristic of VSWR over from 3 GHz to 11 GHz without using any dielectric by making the radiation element 14 the elliptic shape (preferably having an elliptically shaped opening). As a result, it is possible to provide the thin wideband antenna unit which is capable of becoming smaller in size in a case where the dielectric is not used.

While this invention has thus far been described in conjunction with a preferred embodiment thereof, this invention surely is not restricted to the above-mentioned embodiment. For example, the ratio between the y-axis and the x-axis of the elliptic shape in the radiation element 14 is not restricted to one of the above-mentioned embodiment. In addition, a size of the elliptically shaped opening 14a formed in the radiation element 14 is not restricted to one of the above-mentioned embodiment.

1. A wideband antenna unit comprising a ground plate and a flat shaped radiation element disposed on a plane flush with a plane in which said ground plate extends, characterized in that said radiation element has an elliptic shape.

2. The wideband antenna unit as claimed in claim 1, wherein said radiation element and said ground plate are apart from each other by a predetermined feeding distance.

3. The wideband antenna unit as claimed in claim 1, wherein a ratio between an outside diameter in a major axis direction of said elliptic shape and an outside diameter in a minor axis direction of said elliptic shape is 8:5.

4. The wideband antenna unit as claimed in claim 1, wherein said elliptically shaped radiation element has an elliptically shaped opening which is concentric with said elliptic shape.

5. The wideband antenna unit as claimed in claim 4, wherein an inside diameter of said elliptically shaped opening in the minor axis direction of said elliptic shape is half of an outside diameter in the minor axis direction of said elliptic shape.

6. The wideband antenna unit as claimed in claim 4, wherein an inside diameter of said elliptically shaped opening in the major axis direction of said elliptic shape is not more than half of the outside diameter in the major axis direction of said elliptic shape.
